(19) United States
(12) Patent Application Publication
(10) Pub. No.: US 2024/0399557 A1
(43) Pub. Date: Dec. 5, 2024

(54) STRIKING TOOL

(71) Applicant: Techtronic Cordless GP, Anderson, SC (US)

(72) Inventors: Long Chun MOK, Kwai Chung (HK); Lawrence Fung Pok LO, Kwai Chung (HK); Lik HUI, Kwai Chung (HK)

(21) Appl. No.: 18/673,802

(22) Filed: May 24, 2024

(30) Foreign Application Priority Data
May 31, 2023 (CN) CN202310640158.4

(51) Int. Cl. B25G 1/02; B25G 1/10

(52) U.S. Cl. CPC B25G 1/02; B25G 1/102

(57) ABSTRACT

A striking tool, comprising a striking head for performing a striking task and a handle connected to the striking head. The handle extends in a direction substantially transverse to a striking direction of the striking head, and comprises a rigid segment having a first rigidity and a flexible segment having a second rigidity sequentially in a direction away from the striking head, the second rigidity being less than the first rigidity. The handle is provided with a gripping part at a position corresponding to an end of the rigid segment that is connected to the flexible segment. The gripping part for a user to grip on the handle thereof is arranged at the end of the rigid segment that is connected to the flexible segment, so as to correspond to one the nodes of vibration formed on the handle during striking.

### DESCRIPTION

### Technical Field

The present invention relates to a striking tool, in particular a striking tool with vibration reduction functionality.

### Background Art

Striking tools such as claw hammers and sledgehammers have a broad range of uses in industry and everyday life, and generally include a hammer head and a handle extending from the hammer head. A user can grip a remote end of the handle and swing the hammer head to strike a target object. During striking, the reaction force acting on the hammer head from the target object is substantially perpendicular to the longitudinal direction of the handle, causing the handle to vibrate. This vibration is then transmitted to the user through the hand gripping the handle, causing the user sharp discomfort. In the long term, striking work is also liable to cause pathological injury to the joints, bones or muscles of the hand, shoulder or other places, harming the user's physical health.

Thus, it is hoped to provide a striking tool with vibration reduction functionality, to mitigate the abovementioned problems.

### SUMMARY OF THE INVENTION

An object of the present invention is to provide a striking tool with vibration reduction functionality, to alleviate the discomfort which striking causes to the user.

According to one aspect of the present invention, the striking tool comprises:

a striking head, the striking head being constructed to be usable to perform a striking task; and

a handle, the handle being connected to the striking head, and extending in a direction substantially transverse to a striking direction of the striking head, wherein the handle comprises a rigid segment having a first rigidity and a flexible segment having a second rigidity sequentially in a distal direction away from the striking head, the second rigidity being less than the first rigidity, and the handle being provided with a gripping part at a position corresponding to an end of the rigid segment that is connected to the flexible segment.

In some embodiments, the flexible segment has a shorter length than the rigid segment, and the ratio of the length of the rigid segment to the length of the flexible segment is in the range of 4-10, preferably 6-8, and is more preferably 7.

In some embodiments, the handle comprises:

a connecting rod, a proximal end of the connecting rod being connected to the striking head; and

a sheath, the sheath being fitted round the connecting rod and covering a distal end of the connecting rod, wherein a cavity is formed between the distal end of the connecting rod and a distal end of the sheath,

wherein a part of the handle (20) corresponding to the connecting rod (21) forms the rigid segment, and a part of the handle (20) corresponding to the cavity (203) forms the flexible segment.

In some embodiments, the connecting rod is made of a first material, and the sheath is made of a second material, the second material having a lower hardness than the first material; the first material is preferably metal, in particular steel, and/or the second material is preferably hard plastic, in particular polypropylene.

In some embodiments, a counterweight is provided at the distal end of the sheath.

In some embodiments, an end opening is formed at the distal end of the sheath, and the counterweight is constructed as a plug which blocks the end opening; the counterweight is made of metal material, in particular copper or brass.

In some embodiments, the counterweight has a thickness of 5-11 mm in the direction of extension of the handle; preferably, the thickness of the counterweight is 7%-40%, preferably 15%-30%, and more preferably about 20% of the length of the flexible segment.

In some embodiments, an elastic member is provided in the cavity; preferably, the elastic member is constructed as a spring, and/or an elastomeric material filling the cavity.

In some embodiments, the handle further comprises a cover which encases and covers the sheath, the cover being made of a third material, the third material having a lower hardness than a material forming the sheath, and the third material preferably being thermoplastic rubber material.

In some embodiments, the sheath is covered with the cover by an overmoulding process.

In some embodiments, the material forming the cover also fills the cavity formed at the distal end of the sheath, to form an elastic member arranged in the cavity.

In some embodiments, the handle further comprises a filling member, the filling member being arranged between the connecting rod and the sheath in a direction perpendicular to the direction of extension of the handle, and the filling member being made of a fourth material, the fourth material having a lower hardness than a material forming the sheath.

In some embodiments, the fourth material is thermoplastic rubber material.

In some embodiments, the filling member has a sheath-like structure, at least a part of the connecting rod being accommodated in the sheath-like structure.

In some embodiments, the material forming the filling member also fills the cavity formed at the distal end of the sheath, to form an elastic member arranged in the cavity.

In some embodiments, the filling member and the elastic member are integrally formed.

In some embodiments, the connecting rod is provided with a weight reduction hole.

In some embodiments, the handle further comprises a fastener, the fastener passing through the sheath and being connected and fixed to the connecting rod.

In some embodiments, the sheath comprises a proximal segment and a distal segment which are arranged discretely and spaced apart in the direction of extension of the handle.

In some embodiments, a gripping prevention part adjacent to the gripping part is provided on the handle at a position corresponding to that end of the flexible segment which is connected to the rigid segment, the gripping prevention part having a larger dimension than the gripping part in a direction perpendicular to the direction of extension of the handle.

In some embodiments, the gripping prevention part has a length not less than 33 mm in the direction of extension of the handle, and/or the gripping prevention part has a dimension not less than 42.5 mm in a direction perpendicular to the direction of extension of the handle.

According to another aspect of the present invention, also provided is a striking tool comprising:

a striking head, the striking head being constructed to be usable to perform a striking task; and

a handle, the handle being connected to the striking head, and extending in a direction substantially transverse to a striking direction of the striking head, a gripping part being formed on the handle at a position close to a distal end, the distal end being remote from the striking head, wherein the handle is constructed such that during striking, one of vibration nodes formed on the handle is located at the gripping part.

Using the striking tool according to the present invention, the gripping part for a user to grip on the handle thereof is arranged to correspond to one the nodes of vibration formed on the handle during striking, hence the position where the user grips has the smallest vibration amplitude, and the energy of vibration transmitted through the handle to the user's hand and arm is also smallest, thus alleviating the adverse effects of vibration.

### BRIEF DESCRIPTION OF THE FIGURES

To better understand the above and other objectives, features, advantages and functions of the present invention, reference may be made to the preferred embodiments shown in the drawings. In the drawings, identical reference signs denote identical components. It should be understood by a person skilled in the art that the drawings are intended to schematically illustrate preferred embodiments of the present invention, without imposing any limitations on the scope of the present invention, and that the various components in the drawings are not drawn to scale.

FIG. 1 is a 3D view of a striking tool according to a preferred embodiment of the present invention.

FIG. 2 is a 3D exploded view of the striking head and handle of the striking tool shown in FIG. 1 in a separated state.

FIG. 3 is a schematic drawing of vibration nodes on the handle of the striking tool according to the present invention.

FIG. 4 is a 3D exploded view of the striking tool shown in FIG. 1.

FIG. 5 is a view of a section taken along line A-A in FIG. 1; and

FIGS. 6-9 show striking tools according to other preferred embodiments of the present invention.

### KEY TO REFERENCE SIGNS

1, 2, 3, 4 striking tool
10 striking head
11 striking part
12 forked part
13 mounting protrusion
14 first mounting hole
20 handle
201 gripping part
202 gripping prevention part
203 cavity
204 mounting recess
205 second mounting hole
206 rigid segment
20 flexible segment
21 connecting rod
211 distal end of connecting rod
212 third mounting hole
213, 214 weight reduction hole
215 stop part
22, 22′ sheath
221 distal end of sheath
222 end opening
223 fourth mounting hole
224 injection moulding hole
225 proximal segment
226 distal segment
23 counterweight
24 fastener
25 cover
26, 26′ elastic member
27 filling member

### DETAILED DESCRIPTION OF EMBODIMENTS

Specific embodiments of the present invention are now described in detail with reference to the drawings. The embodiments described here are merely preferred embodiments according to the present invention. A person skilled in the art could conceive of other ways of implementing the present invention on the basis of the preferred embodiments, and such other ways shall likewise fall within the scope of the present invention.

The present invention provides a striking tool, which specifically may be in the form of a hammer, such as a claw hammer. A striking tool according to the present invention is described below with reference to the drawings.

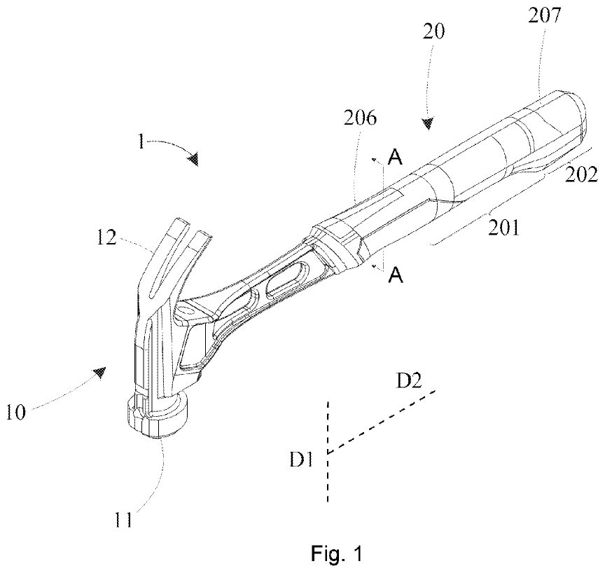

As shown in FIG. 1, a striking tool 1 according to some embodiments may comprise a striking head 10 and a handle 20. The striking head 10 may also be called a hammer head. One end of the striking head 10 is provided with a striking part 11, which has a substantially flat or outwardly protruding end face, for performing striking tasks. A direction in which a user swings the striking tool 1 to make the striking head 10 move towards a target object to be struck may be called the striking direction, shown as D1 in FIG. 1. An end of the striking head 10 opposite the striking part 11 is provided with a forked part 12, which comprises two legs spaced apart from each other, with a substantially V-shaped opening formed between the two legs. An end of a nail can be engaged in the opening, to pull out the nail.

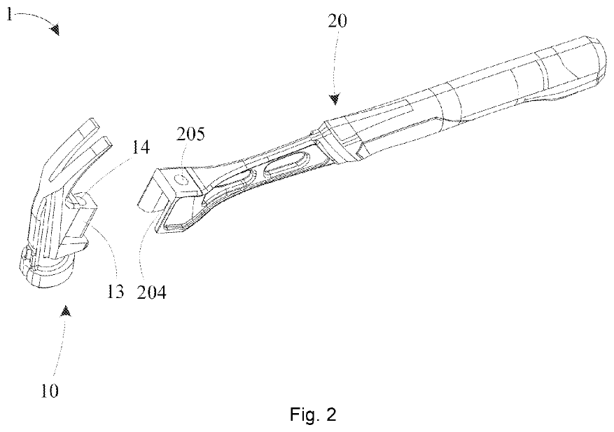

The handle 20 is connected to the striking head 10, and extends substantially transversely to the striking direction D1 of the striking head 10. The direction of extension of the handle 20 is shown as D2 in FIG. 1. The end of the handle 20 that faces the striking head 10 is called the “proximal end”, and the end of the handle 20 that is remote from the striking head 10 is called the “distal end”. The components mentioned below that form the handle 20 follow the same definition of directions. The handle 20 is connected by its proximal end to the striking head 10. Specifically, as shown in FIG. 2, the striking head 10 is provided with a mounting protrusion 13 and a first mounting hole 14. The proximal end of the handle 20 is provided with a mounting recess 204 adapted to the shape of the mounting protrusion 13, and is also provided with a second mounting hole 205. The striking head 10 is connected to the handle 20 through engagement of the mounting protrusion 13 in the mounting recess 204, while the first mounting hole 14 is aligned with the second mounting hole 205, and a fastener such as a screw can then be fixed in the first mounting hole 14 and the second mounting hole 205, to prevent loosening of the striking head 10.

It will be understood that other suitable methods of connection may also be used for connecting the striking head to the handle. For example, the proximal end of the handle is configured as a columnar structure, while a mounting through-hole adapted thereto is provided on the striking head, and the columnar structure is engaged in the mounting through-hole, or a threaded structure is provided to screw into the mounting through-hole to realize the connection, and the firmness of the connection can be increased by adding friction material or welding, etc.; or the striking head and handle may be connected directly by welding, or the striking head and handle may be integrally injection moulded.

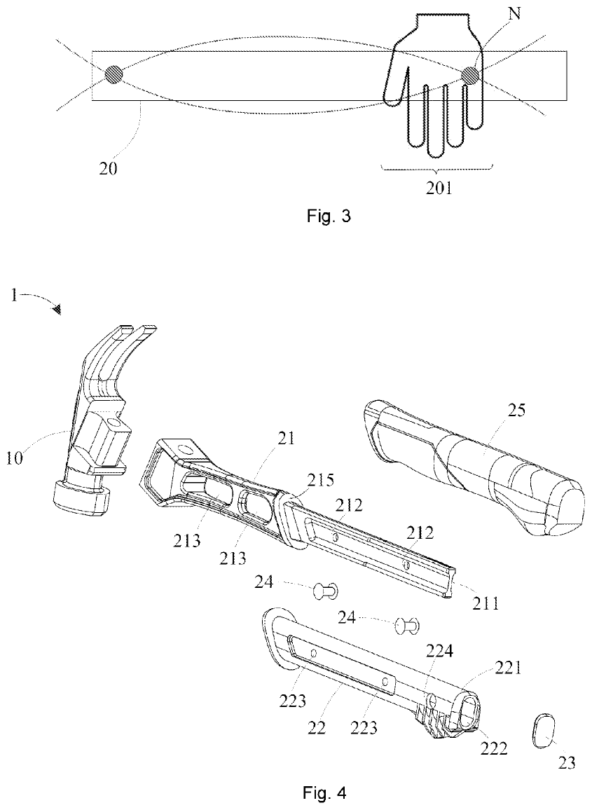

At a position close to its distal end, the handle 20 forms a gripping part 201 for the user to grip. When performing a striking task, the striking head 10 strikes the target object, and at the same time, the target object applies a reaction force to the striking head 10, causing vibration. It will be understood that the direction of the reaction force is substantially in the striking direction D1, i.e. substantially perpendicular to the direction of extension D2 of the handle 20. The handle 20 may be regarded as an elongated rod extending in direction D2. Thus, the vibration in the handle 20 caused by the reaction force may be regarded as a transverse wave propagating from the proximal end of the handle 20 towards the distal end thereof. As shown schematically in FIG. 3, in the process of transverse wave transmission, there is a position of minimum (or zero) vibration amplitude, and this position is called a vibration node (N), or may also be called a wave node. According to the present invention, the handle 20 is constructed such that one of the vibration nodes N of the vibration (i.e. transverse wave) in the handle 20 caused by the reaction force applied by the target object is located at the gripping part 201. In this way, the user's hand that grips the handle 20 experiences the vibration with the smallest amplitude, so the adverse effects of vibration are alleviated.

In some embodiments, the following structure may be used to ensure that one of the vibration nodes is at the gripping part 201. Continuing to refer to FIG. 1, the handle 20 is configured to comprise two parts: a rigid segment 206 and a flexible segment 207. The rigid segment 206 has a first rigidity, and the flexible segment 207 has a second rigidity less than the first rigidity. The striking head 10 is mounted at the proximal end of the rigid segment 206. The rigid segment 206 has higher rigidity, and can thus provide full rigid support to the striking head 10, so as to meet the needs of striking work. The flexible segment 207 is connected to the distal end of the rigid segment 206. The gripping part 201 is disposed at a position on the handle 20 that corresponds to the distal end of the rigid segment 206. The flexible segment 207 has lower rigidity, and experiences more vibration than the rigid segment 206; consequently, the distal end of the rigid segment 206 can have a smaller vibration amplitude, so as to form a vibration node. Preferably, the length of the flexible segment 207 is set to be smaller, or much smaller, than the length of the rigid segment 206. In some embodiments, the ratio of the length of the rigid segment 206 to the length of the flexible segment 207 is 4-10, preferably 6-8,and more preferably 7.

It will be understood that here, the terms “rigid segment” and “flexible segment” are intended to make clear that there is a difference in rigidity between the two parts of the handle, but are not used to limit characteristics of the two parts other than rigidity.

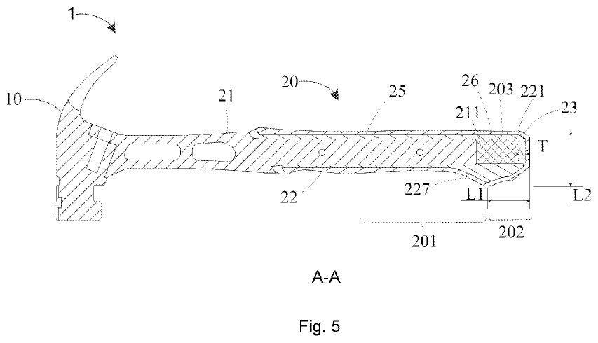

Referring to FIGS. 4 and 5, in some embodiments, the handle 20 comprises a connecting rod 21 and a sheath 22, which both have a substantially elongated structure. The connecting rod 21 is for connecting to the striking head 10. That is, the structure for connecting to the striking head 10, including the mounting recess 204 and the second mounting hole 205, is arranged on the connecting rod 21, specifically at the proximal end thereof. It can be seen from a distal end 211 of the connecting rod 21 that the cross section of the connecting rod 21 perpendicular to the longitudinal direction thereof is substantially constructed as an H-shaped structure. Such a structure has good force-bearing characteristics, and is able to meet the force-bearing demands of striking. Furthermore, the connecting rod 21 is also provided with weight reduction holes 213 at positions close to the proximal end thereof, which can reduce the overall mass of the striking tool 1 while ensuring structural strength, so that less effort is required.

The sheath 22 is fitted round the connecting rod 21, and covers the distal end 211 of the connecting rod 21. Furthermore, the distal end 211 of the connecting rod 21 is separated from a distal end 221 of the sheath 22 by a predetermined distance, so that a cavity 203 is formed inside the sheath 22 at a position between the distal end 211 of the connecting rod 21 and the distal end 221 of the sheath 22. That is, the distal end of the handle 20 is formed as a hollow structure. The hollow configuration can reduce the mass of this structural segment, helping to transfer vibration from the gripping part 201 to a position further towards the rear of the handle 20. It can be seen from FIG. 1 that a part of the handle 20 corresponding to the connecting rod 21 is formed as the rigid segment 206, and a part of the handle 20 corresponding to the cavity 203 is formed as the flexible segment 207.

In some embodiments, the connecting rod 21 may be made of a material having higher hardness and rigidity, so as to meet the requirements of striking with the striking tool 1. Preferably, the material from which the connecting rod 21 is made may be metal, in particular steel. The sheath 22 may be made of a material having a lower hardness than the connecting rod 21. That is, the sheath 22 is softer than the connecting rod 21. Preferably, the material from which the sheath 22 is made may be hard plastic, in particular polypropylene (PP). Making the sheath 22 from a softer material than the connecting rod 21 helps to transfer vibration from the gripping part 201 to another position.

In some embodiments, a counterweight 23 is provided at the distal end of the handle 20. Having configured the part between the distal end 211 of the connecting rod 21 and the distal end 221 of the sheath 22 to be hollow to reduce the mass of this structural segment, further providing the counterweight 23 at the distal end of the handle 20 can also promote the transfer of vibration from the gripping part 201. In the embodiment shown, the distal end 221 of the sheath 22 substantially forms the distal end of the handle 20. Preferably, and end opening 222 is formed in the distal end 221 of the sheath 22, and the counterweight 23 is constructed as a plug which is attached to the sheath 22 and blocks the end opening 222. Preferably, the counterweight 23 may be made of metal, e.g. copper or brass, etc. Furthermore, the thickness T of the counterweight 23 in the direction of extension D2 of the handle 20 is set to be 5-11 mm, so that the counterweight 23 does not adversely affect the hollow structure between the distal end 211 of the connecting rod 21 and the distal end 221 of the sheath 22. In some embodiments, the thickness of the counterweight 23 is 7%-40%, preferably 15%-30%, more preferably about 20%, of the length of the flexible segment 207.

To ensure that the user can correctly grip at the position of the gripping part 201, in some embodiments, a gripping prevention part 202 is provided at the distal end of the handle 20; this may be arranged at a position corresponding to that end of the flexible segment 207 which is connected to the rigid segment 206, and specifically may be realized by increasing a radial dimension of the gripping prevention part 202, such that the gripping prevention part 202 is less easily gripped than the gripping part 201. Preferably, as shown in FIG. 5, the length of extension L1 of the gripping prevention part 202 may be set to be not less than 33 mm. Furthermore, the gripping prevention part 202 may have a maximum radial dimension L2, which may be set to be not less than 42.5 mm, at a position adjacent to the gripping part 201. In this way, a placement region 227 for placing the little finger may also be formed on the gripping part 201 at a position close to the maximum radial dimension of the gripping prevention part 202.

In some embodiments, the handle 20 is also provided with a cover 25 which encases and covers the sheath 22. Preferably, the cover 25 is made of a material having a lower hardness than the sheath 22, i.e. the cover 25 is softer than the sheath 22. Preferably, the material from which the cover 25 is made may be thermoplastic rubber material (TPR). This type of material allows the cover 25 to be directly made and shaped on the outside of the sheath 22 by overmoulding.

In some embodiments, an elastic member 26 may also be provided in the cavity 203, to absorb vibration. The elastic member 26 may be obtained by filling the cavity 203 with an elastomeric material. For example, the material of the cover 25 is soft, does not affect mass much, and has good elasticity, so the material from which the cover 25 is formed may be used to fill the cavity 203, so as to form the elastic member 26. Preferably, as shown in FIG. 4, an injection moulding hole 224 is provided on the sheath 22 at a position corresponding to the cavity 203. When making the cover 25 by overmoulding, or in other steps, the cavity 203 may be filled with molten material via the injection moulding hole 224.

The striking tool 1 shown in the drawings may be assembled by the following steps. Firstly, the striking head 10 and the connecting rod 21 which have been made and shaped are connected. The distal end 211 of the connecting rod 21 is then inserted into the sheath 22. At the same time, the counterweight 23 is attached to the end opening 23 of the sheath 22. The cover 25 can then be made and shaped on the sheath 22 directly by overmoulding, while filling the cavity 203 with the same material as the cover 25 via the injection moulding hole 224. Preferably, a stop part 215 may be provided in a middle part of the connecting rod 21, and the proximal end of the sheath 22 abuts the stop part 215. In this way, the relative mounting positions of the connecting rod 21 and the sheath 22 may be accurately fixed. Furthermore, the connecting rod 21 and the sheath 22 may be further securely connected by means of fasteners 24 such as rivets. For example, as shown in FIG. 4, third mounting holes 212 are provided in a part of the connecting rod 21 that is inserted into the sheath 22, and fourth mounting holes 223 are provided at corresponding positions on the sheath 22. After fitting the sheath 22 in place but before making the cover 25, the fasteners 24 may be passed through the aligned third mounting holes 212 and fourth mounting holes 223, to fasten the connecting rod 21 to the sheath 22.

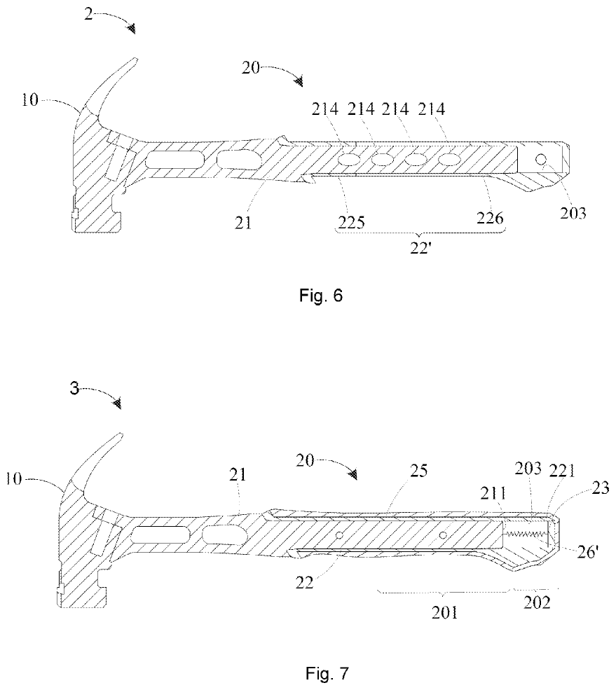

FIGS. 6-9 show striking tools according to other embodiments of the present invention. The structures therein are largely the same as the structure of the striking tool 1 shown in FIGS. 1-5, and shown with the same reference labels.

The difference is that in the embodiment shown in FIG. 6, the sheath 22′ is constructed as a split structure formed of two parts, comprising a proximal segment 225 and a distal segment 226, which are separated from one another in the direction of extension of the handle 20. Furthermore, weight reduction holes 214 are also provided in the part of the connecting rod 21 that is disposed within the sheath 22′. In addition, it will be understood that the cover is omitted in FIG. 6, so as to better show the split structure of the sheath 22′.

In the embodiment shown in FIG. 7, an elastic body 26′ located in the cavity 203 of the handle 20 is formed of a spring, and specifically may be a suitable spring in any form such as a coil spring or a spring plate. It is connected at one end to the distal end 211 of the connecting rod 21, and at the other end to the counterweight 23 blocking the cavity 203. In some other embodiments, an clastic body may also be formed through a combination of a spring and filling with an elastomeric material; for example, a spring structure is first arranged in the cavity 203, and then the cavity is filled with an elastomeric material.

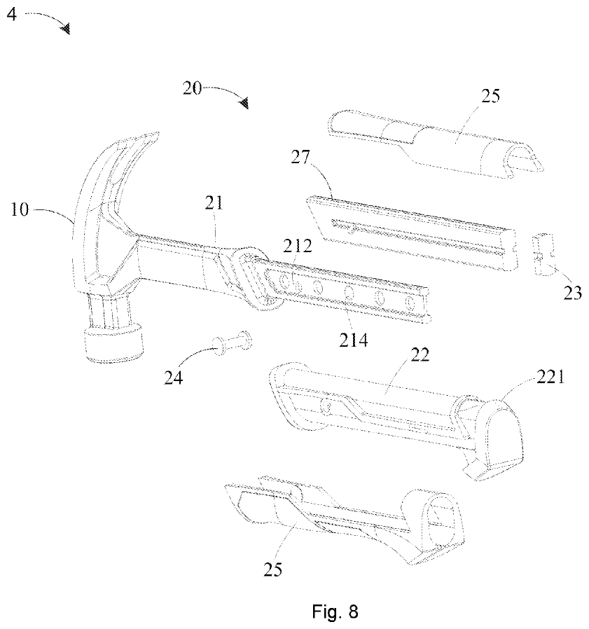

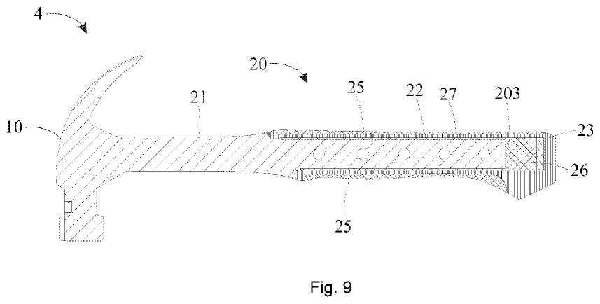

In the embodiments shown in FIGS. 8-9, the striking head 10 and the connecting rod 21 of the handle 20 are integrally formed. The cover 25 is a split member formed of two parts which respectively cover an upper part and a lower part of the sheath 22. The distal end 221 of the sheath 22 is constructed as a closed structure. The counterweight 23 may be arranged in the sheath 22, abutting an inside wall of the distal end 221.

In addition, the striking tool 4 further comprises a filling member 27, which is arranged between the connecting rod 21 and the sheath 22 in a direction perpendicular to the direction of extension of the handle 20. For example, the filling member 27 may have a sheath-like structure. At least a part of the connecting rod 21 extends into the sheath-like structure. The connecting rod 21 and the sheath-like structure are then extended into the sheath 22 together. The filling member 27 may be made of a material having a lower hardness than the sheath 22, i.e. the filling member 27 is softer than the sheath 22. Preferably, the material from which the filling member 27 is made may be thermoplastic rubber material (TPR). Similarly, the cavity 203 may be filled with the material from which the filling member 27 is formed, so as to form the elastic member 26. The filling member 27 and the elastic member 26 may be formed as an integral structure.

Several embodiments of the present invention have been described as examples above. Those skilled in the art will understand that various features of different embodiments above may replace each other or be combined without going beyond the inventive concept of the present invention, and the new embodiments thus obtained shall still fall within the scope of protection of the present invention.

The above description of various embodiments of the present invention is provided to a person of ordinary skill in the relevant art for descriptive purposes. The present invention is not intended to be exclusive or limited to a single disclosed embodiment. On the basis of what is described above, a person of ordinary skill in the art will understand various substitutes for and variants of the present invention. Therefore, although some alternative embodiments have been specifically described, a person of ordinary skill in the art will understand, or develop with relative ease, other embodiments. The present invention is intended to include all substitutes for, alterations to, and variants of the present invention described herein, as well as other embodiments falling within the spirit and scope of the present invention described above.

What is claimed is:

1. A striking tool comprising:
a striking head, the striking head being constructed to be usable to perform a striking task; and
a handle, the handle being connected to the striking head, and extending in a direction substantially transverse to a striking direction of the striking head, wherein the handle comprises a rigid segment having a first rigidity and a flexible segment having a second rigidity sequentially in a distal direction away from the striking head, the second rigidity being less than the first rigidity, and the handle being provided with a gripping part at a position corresponding to an end of the rigid segment that is connected to the flexible segment.

2. The striking tool according to claim 1, wherein the flexible segment has a shorter length than the rigid segment.

3. The striking tool according to claim 2, wherein the ratio of the length of the rigid segment-to the length of the flexible segment is in the range of 4-10.

4. The striking tool according to claim 1, wherein the handle comprises:
a connecting rod, a proximal end of the connecting rod being connected to the striking head; and
a sheath, the sheath being fitted round the connecting rod and covering a distal end of the connecting rod, wherein a cavity is formed between the distal end of the connecting rod and a distal end of the sheath,
wherein a part of the handle corresponding to the connecting rod forms the rigid segment, and a part of the handle corresponding to the cavity forms the flexible segment.

5. The striking tool according to claim 4, wherein the connecting rod is made of a first material, and the sheath is made of a second material, the second material having a lower hardness than the first material.

6. The striking tool according to claim 5, wherein the first material is metal, and/or the second material is hard plastic.

7. The striking tool according to claim 4, wherein a counterweight is provided at the distal end of the sheath.

8. The striking tool according to claim 7, wherein an end opening is formed at the distal end of the sheath, and the counterweight is constructed as a plug which blocks the end opening.

9. The striking tool according to claim 7, wherein the counterweight is made of metal material.

10. The striking tool according to claim 7, wherein the counterweight has a thickness of 5-11 mm in the direction of extension of the handle.

11. The striking tool according to claim 10, wherein the thickness of the counterweight is 7%-40% of the length of the flexible segment.

12. The striking tool according to claim 4, wherein an elastic member is provided in the cavity.

13. The striking tool according to claim 12, wherein the elastic member is constructed as a spring or an elastomeric material filling the cavity.

14. The striking tool according to claim 4, wherein the handle-further comprises a cover which encases and covers the sheath, the cover being made of a third material, the third material having a lower hardness than a material forming the sheath.

15. The striking tool according to claim 14, wherein the third material is thermoplastic rubber material.

16. The striking tool according to claim 14, wherein the sheath is covered with the cover by an overmoulding process.

17. The striking tool according to claim 14, wherein the material forming the cover also fills the cavity formed at the distal end of the sheath, to form an elastic member arranged in the cavity.

18. The striking tool according to claim 4, wherein the handle further comprises a filling member, the filling member-being arranged between the connecting rod and the sheath in a direction perpendicular to the direction of extension of the handle, and the filling member being made of a fourth material, the fourth material having a lower hardness than a material forming the sheath.

19. The striking tool according to claim 18, wherein the fourth material is thermoplastic rubber material.

20. The striking tool according to claim 18, wherein the filling member has a sheath-like structure, at least a part of the connecting rod being accommodated in the sheath-like structure.

21. The striking tool according to claim 18, wherein the material forming the filling member also fills the cavity formed at the distal end of the sheath, to form an elastic member arranged in the cavity.

22. The striking tool according to claim 21, wherein the filling member and the elastic member are integrally formed.

23. The striking tool according to claim 4, wherein the connecting rod is provided with a weight reduction hole.

24. The striking tool according to claim 4, wherein the handle further comprises a fastener, the fastener passing through the sheath and being connected and fixed to the connecting rod.

25. The striking tool according to claim 4, wherein the sheath comprises a proximal segment and a distal segment-which are arranged discretely and spaced apart in the direction of extension of the handle.

26. The striking tool according to claim 1, wherein a gripping prevention part adjacent to the gripping part-is provided on the handle at a position corresponding to that end of the flexible segment which is connected to the rigid segment, the gripping prevention part having a larger dimension than the gripping part in a direction perpendicular to the direction of extension of the handle.

27. The striking tool according to claim 26, wherein the gripping prevention part has a length not less than 33 mm in the direction of extension of the handle, or the gripping prevention part has a dimension not less than 42.5 mm in a direction perpendicular to the direction of extension of the handle.

28. A striking tool comprising:
a striking head, the striking head being constructed to be usable to perform a striking task; and
a handle, the handle being connected to the striking head, and extending in a direction substantially transverse to a striking direction of the striking head, a gripping part being formed on the handle at a position close to a distal end, the distal end being remote from the striking head, wherein the handle is constructed such that during striking, one of vibration nodes formed on the handle is located at the gripping part.
